(19) United States
(12) Patent Application Publication
(10) Pub. No.: US 2008/0100371 A1
(43) Pub. Date: May 1, 2008

(54) DUAL RAIL GENERATOR

(76) Inventors: Fabrice Paillet, Hillsboro, OR (US); Peter Hazucha, Beaverton, OR (US); Gerhard Schrom, Hillsboro, OR (US); Tanay Karnik, Portland, OR (US); Sung T. Moon, Hillsboro, OR (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/553,184

(22) Filed: Oct. 26, 2006

(51) Int. Cl. G05F 1/00

(52) U.S. Cl. 327/543

(57) ABSTRACT

Some embodiments disclosed herein provide dual rail generators to provide a high and a low supply rail.

### TECHNICAL FIELD

The present invention relates generally to signal generator circuits and in particular, to a dual rail generator circuit for generating low and high rail supplies. A dual rail generator may be used in various applications including but not limited to a novel fixed-reference based pulse width modulator (see commonly owned U.S. Patent Application entitled FIXED REFERENCE BASED PULSE WIDTH MODULATOR, filed concurrently with this application) and in a power management system to provide a variable, dual supply.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1A is a block diagram of a dual rail generator in accordance with some embodiments.

FIG. 1B is a graph illustrating a dual rail signal in accordance with some embodiments.

FIG. 2 is a signal flow diagram of a dual rail generator in accordance with some embodiments.

FIG. 3 is a schematic diagram of a dual rail generator in accordance with the signal flow diagram of FIG. 2 in accordance with some embodiments.

FIG. 4 is a schematic diagram of a dual rail generator in accordance with FIGS 2 and 3 in accordance with some embodiments.

FIG. 5 is a block diagram of a computer system having a microprocessor with at least one dual rail circuit in accordance with some embodiments.

### DETAILED DESCRIPTION

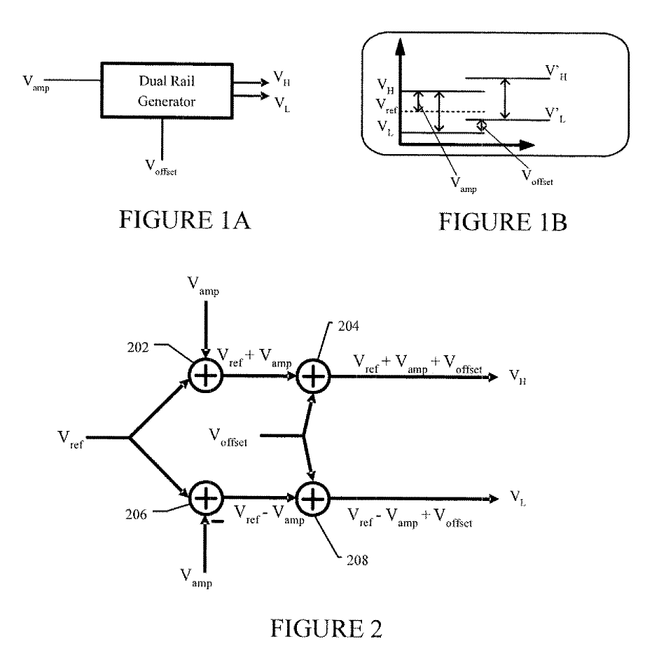

FIGS. 1A and 1B generally show a dual rail generator providing first and second (High and Low) voltage rail outputs, V_{H} and V_{L}, based on applied amplitude (Vₐₘₚ) and offset (V_{offset}) inputs, relative to a reference voltage (V_{ref}). (In the depicted embodiment, the reference voltage is fixed and set within the dual rail generator and thus is not shown in FIG. 1A. However, in some embodiments, an externally applied and/or variable reference could be used. Moreover, the reference voltage could have a value of 0 in some embodiments.) Mathematically, V_{H}=V_{ref}+Vₐₘₚ+V_{offset} and V_{L}=V_{ref}+Vₐₘₚ+V_{offset}. As graphically illustrated in FIG. 1B, this results in the difference between the High and Low rails being two times (twice) the applied amplitude. They are symmetrical about the reference voltage (V_{ref}) when there is no offset (V_{offset} equals 0), but if an offset is applied, the High and Low rails are equally shifted, either upward or downward in accordance with the offset value. Thus, by appropriately adjusting the V_{offset} and Vₐₘₚ signals, numerous different V_{H}−V_{L} combinations may be attained.

FIG. 2 shows a signal flow representation of the dual rail generator of FIG. 1A in accordance with some embodiments. It comprises adders 202, 204, 206, and 208 to generate the High and Low rails (V_{H}, V_{L}) in accordance with the equations set forth above. The reference voltage V_{ref} is applied to adders 202, 204 and respectively added to Vamp and −Vₐₘₚ thereby generating V_{ref}+Vₐₘₚ and V_{ref}−Vₐₘₚ at their outputs. In turn, these outputs are respectively added to the offset (V_{offset}) at adders 204 an 208 to generate V_{H} and V_{L}, as indicated.

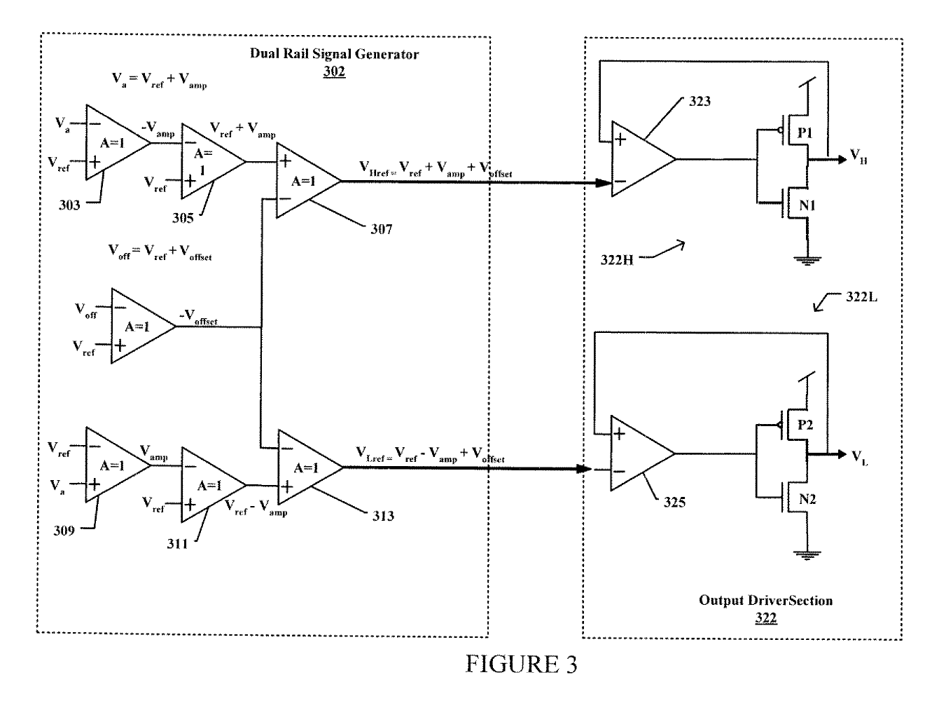

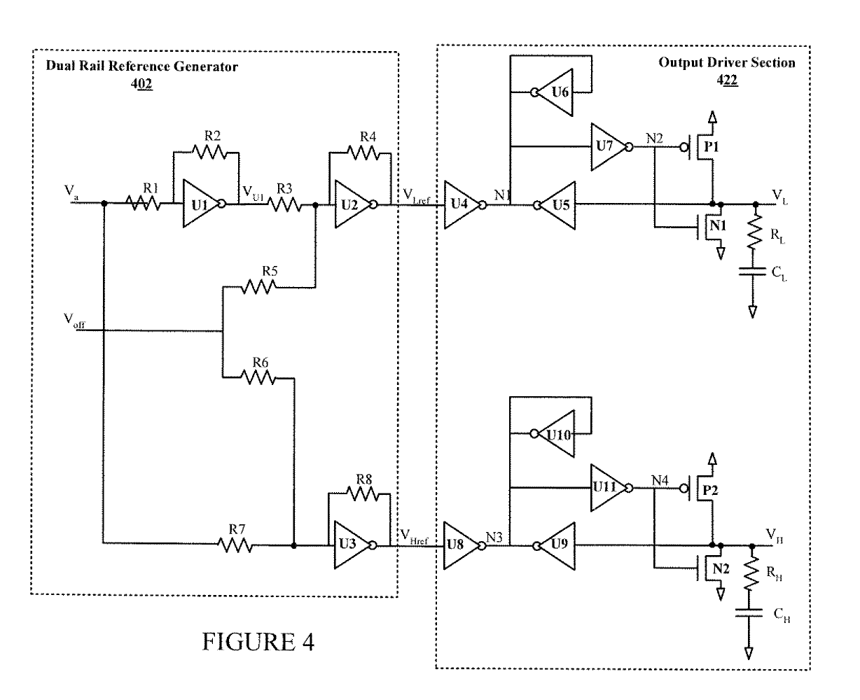

FIG. 3 is a schematic diagram of a circuit to implement the signal flow diagram of FIG. 2 and generate the High and Low reference signals, V_{H} and V_{L}. However, instead of using the above described amplitude (Vₐₘₚ) and offset (V_{offset}) signals, referenced versions, Vₐ and V_{off} (where Vₐ=V_{ref}+Vₐₘₚ and V_{off}=V_{ref}+V_{offset}) are used instead to more conveniently accommodate circuits (such as the circuit described below with reference to FIG. 4) that have an inherent reference component. Therefore, Va and Voff are still amplitude and offset signals, as are those used for the diagram of FIG. 2, except that they have an additional reference component built within.

The dual rail generator of FIG. 3 generally comprises a dual rail signal generator circuit 302 and an output driver section 322, coupled together as indicated. The dual rail signal generator 302 comprises adder circuits 303, 305, 307, 308, 309, 311, and 313, coupled together as shown to appropriately add/subtract Vref, Va, and Voff in accordance with the above equations to generate High and Low reference rails, V_{Href} and V_{Lref}. The reference rails, V_{Href} and V_{Lref}, correspond to V_{H} and V_{L} above in value but may have sufficient current delivery capability to supply an actual load. Accordingly, they are amplified in the output driver section 322 by linear voltage regulators 322H and 322L, respectively, which provide a their outputs the regulated High and Low rails, V_{H} and V_{L}.

In the depicted embodiment, each adder circuit in the dual rail reference generator section 302 has a voltage gain of A=1 and is implemented with a difference adder, which subtracts a first value from a second value. As shown in FIG. 3, they are appropriately configured to perform the above equations for VH (V_{Href}) and V_{L} (V_{Lref}). It should be appreciated that they could be implemented with any suitable circuit for performing an addition or subtraction operation on two analog inputs, many of which are known to persons of ordinary skill. (Below, however, with reference to FIG. 4, a novel approach using inverters is presented.) For simplicity sake, the gain of each adder is one but this certainly is not required, The High and Low rail equations defined above could be implemented with adders having other gain values and depending on desired applications, variations on the above described equations may be desired (e.g., the addends could be weighted differently).

Each regulator (322H or 322L) is a unity gain linear regulator formed from an amplifier coupled to PMOS and NMOS transistors, all coupled together as shown. The High-side regulator 322H is formed from amplifier 323, PMOS transistor P1 and NMOS transistor N1. It receives at its input (negative input of amplifier 323) the High reference signal (V_{Href}), while its output is coupled to the gates of transistors P1 and N1. In turn, the transistor outputs (at their drains) are coupled back to the positive input of amplifier 323. The Low side regulator 322L is configured in the same way except that it is formed from amplifier 325, PMOS transistor P2 and NMOS transistor N2. (Note the term “PMOS transistor” refers to a P-type metal oxide semiconductor field effect transistor. Likewise, “NMOS transistor” refers to an N-type metal oxide semiconductor field effect transistor. It should be appreciated that whenever the terms; “transistor”, “MOS transistor”, “NMOS transistor”, or “PMOS transistor” are used, unless otherwise expressly indicated or dictated by the nature of their use, they are being used in an exemplary manner. They encompass the different varieties of MOS devices including devices with different VTs and oxide thicknesses to mention just a few. Moreover, unless specifically referred to as MOS or the like, the term transistor can include other suitable transistor types, erg., junction-field-effect transistors, bipolar-junction transistors, and various types of three dimensional transistors, known today or not yet developed.)

Because each amplifier is configured with negative feedback, the voltage at the input terminals are forced to equal one another. This results in the output voltages (V_{H}, V_{L}) tracking (or following) the input voltages (V_{Href}, V_{Lref}) and at the same time: being able to drive actual loads. Note that transistors N1 and P2 are represented with dashed lines. This is so because in some embodiments, the High side rail V_{H} may be used to primarily source current to its load, while the Low side rail V_{L} may primarily be used to sink current from its load. In such a case, N1 and P2 could be smaller than P1 and N2 or even omitted.

FIG. 4 shows a dual rail generator circuit, in accordance with some embodiments, that uses inverters for synthesis and regulation of the two output rails, V_{H} and V_{L}, based on analog amplitude and offset voltage inputs, Vₐ and V_{off}, respectively. Vₐ and V_{off} are referenced versions of Vₐₘₚ and V_{offset} as defined above, based on an inherent reference voltage, V_{ref}, corresponding to the trip point of inverters used in the circuit.

The dual rail generator generally comprises a dual rail reference generator section 402 coupled to an output driver section 422. The reference generator portion 402 comprises Inverters U1, U2, U3 and resistors R1 to R8, while the output driver section 422 comprises inverters 114 to U11, transistors P1, P2, N1, N2, resistors RH and RL, and capacitors CH and CL, all coupled together as shown. In some embodiments, the inverters are formed from PMOS and NMOS transistors with their gates coupled together to provide an inverter input and their drains coupled together to provide an inverter output. In some embodiments, the inverters (except possibly U7 and U11) are designed to have the same trip points, and U4-U5, U8, and U9 are sized to have the same strengths. For example, the PMOS and NMOS transistors in U4-U5, and U8-U9 may be designed to have the same current carrying capability. The actual trip point value is not necessarily critical, so long as the values in the inverters are sufficiently close to one another, although it may be desirable to target the trip point at VCC/2 so that V_{H} and V_{L} may have a wider operating range. U6 and U10 may be designed to be weaker in strength. In contrast, U7 and U11 may be designed to be stronger, and their trip points need not necessarily be the same as the others,

The reference generator portion 402 will initially be discussed. Inverters U1 and U2, along with resistors R1-R4, make up a low-side section to generate a reference signal (V_{Lref}) for the low rail, while inverter L3 and resistors R7 and R8 make up the high-side section to generate the high rail reference (V_{Href}). With the depicted embodiment, the high and low side sections generate inverted versions, relative to inverter trip points, of the high and low side rails. The output driver section thus comprises driver circuits that invert the reference signal to provide the high and low rails.

Inverter U1 is configured to be an inverting amplifier having a gain of about −R2/R1 acting on the Vₐₘₚ component of Vₐ, relative to Vref(the trip point of the inverter). That is, an inverter, with feedback, acts similarly to an amplifier with negative feedback, except that it has an inherent offset corresponding to its trip point. Therefore, with resistors R1 and R2 configured as shown, the inverter's output voltage is equal to: (−R2/R1)(Va−Vref)+V_{ref}. When R1 and R2 are equal, this reduces to: 2V_{ref}−Vₐ, or V_{ref}−Vₐₘₚ, so, for example, if V_{ref}=0.6V and Vₐ=0.8V, then V_{U1} would be 0.4V. (Note that this analysis assumes that the inverter gain is high, which may not be completely accurate. Accordingly, in some embodiments, the gain terms may be “tweaked” to achieve desired results, e.g., for a particular operating range.)

Inverter amplifier circuits U2 and U3 are essentially the same. They are configured to function as summing inverter amplifiers (relative to the inverter trip points, i.e., the reference voltage). Summing inverter U2 sums the output from U1 (V_{U1}, which is V_{ref}−Vₐₘₚ) with V_{off}(V_{offset}(V_{offset}+V_{ref}), while U3 sums Vₐ with V_{off}. (Note that the high-side section doesn't have an inverter stage corresponding to U1 in the low-side path. This is so because in the high-side path, to generate V_{L}, the Vamp component in Va is added rather than subtracted.)

The gain and relative weighting for the summed terms are determined by their associated resistors. With regard to U2, R4/R3 determines the gain for the V_{U1} term, while R4/R5 determines the gain for the V_{off} term. The output of U2 (V_{Lref}) will be: V_{Lref}=−(R4/R3)(V_{U1}−V_{ref})−(R4/R5)(V_{off}−V_{ref})+V_{ref}. Similarly, with regard to U3, R5/R7 determines the gain of the applied Vₐ term, while R8/R6 determines the gain of the offset term V_{off}. The output, V_{Href}, is: V_{Href}=−(R8/R7)(Vₐ−V_{ref})−(R8/R6)(V_{off}'V_{ref})+V_{ref}. Thus, if R3, R4, and R5 are the same and if R6, R7, and R8 are the same, the output equations reduce to: V_{Lref}−(V_{U1}−V_{ref})−(V_{off}−V_{ref})+V_{ref} and V_{Href}(Vₐ−V_{ref})−(V_{off}−V_{ref})+V_{ref}. The outputs, V_{Lref} and V_{Href}, result in inverted, relative to the inverter trip points, versions of the high and low rails. The amplifiers (or drivers) in the output driver section 422 correct this in providing the high and low rails.

As an example to illustrate how the dual rail reference generator 402 works, assume that R1=R2 (e.g., 10K Ohms), R3=R4=R5 (eg., 10K Ohms) and R6=R7=R8 (e.g., 10K Ohms). Also assume, as with the above example, that V_{ref}=0.6V, the offset is to be 0.1V (the applied V_{off} would thus be 0.7V), and Vₐₘₚ is to be 0.2V (the applied Vₐ would thus be 0.8V and V_{U1} would be 0.4V). With these values, the high and low rails should be 0.9V and 0.5V, respectively. Applying these values to the equations for U2 and U3, the Low reference voltage, V_{Lref}, would be 0.7 while the high reference voltage, V_{Href}, would be 0.3V. This is correct because after being inverted by the output driver sections (relative to the 0.6V reference), they become 0.5V and 0.9V respectively, which are the correct values.

(Again, it should he appreciated that the actual resistor values, amplifier gains, and weights are not necessarily important, so long as the overall transfer functions for V_{H}/(Vₐ, V_{off}) and V_{L}(Vₐ, V_{off}) provide for sufficiently consistent, predictable results for acceptable input and output operating ranges. This also applies to the circuits in the output driver section 422, discussed in the following section.)

The output driver section 422 comprises inverters U4 to U11, MOS transistors N1, N2, P1, P2, and load resistors and capacitors R_{H}, R_{L}, C_{H}, and C_{L}. The low side driver is formed from inverters U4 to U7, transistors P1, N1, resistor RL, and capacitor CL; while the high side driver comprises inverters U8 to U11, transistors P2, N2, resistor RH, and capacitor CH.

With the low side driver, inverters U4 and U5 are coupled together at their inverter outputs at node N1 in a mirrored configuration. With this configuration, they act like an inverting analog amplifier connected in a negative feedback to provide at an input (V_{Lref}, V_{L}) the analog inverse (mirror) of the other, relative to V_{ref} (inverter trip points, which are to be the same). Therefore, the voltage at V_{L} will be: V_{L}=2V_{ref}−V_{Lref}. Note that V_{L} functions both as an input and an output. It may be helpful to think of V_{Lref} and V_{L} as ends of a see-saw, with a fulcrum in the middle pushing up to the reference voltage level. As one side goes up, the other goes down and when perfectly balanced, the inputs and node N1 approach V_{ref}. On the other hand, when V_{Lref} goes up or down, i.e., in response to changes in Vₐ and/or V_{off}, it forces the voltage (V_{L}) at the other end of the “see-saw” to go down or up in the opposite direction accordingly. (Note that node N1 does not typically settle at precisely V_{ref} but is usually close to it due to the gain in the following stage (U7); the voltage at node N1 will necessarily vary with the current needed to be sunk or delivered to/by N1 or P1. N2 can vary anywhere between Vcc and Vss and N1 should vary around V_{ref} by up to about (Vcc−V_{ref})/gain or V_{ref}/gain, typically up to about 100 mV in some embodiments.)

Inverter U6 is a relatively weak inverter, designed to have its trip point at V_{ref}. With its input shorted to its output, it generates at its output the reference signal, V_{ref}, and is coupled to the inverter outputs of mirrored inverters U4, U5 (node N1) to provide them with a relatively weak load. It serves to reduce their gain, acting like ballast to stabilize their analog performance.

Inverter U7 is relatively large (e.g., twice the current carrying capability as inverters U1, U2, U3, U4, or U5) and has it trip point relatively close to those of the others, but this is not critical. It functions to drive push/pull output transistors P1, N1 to appropriately regulate V_{L}. Thus, U4/U5, U6, and P1/N1 form the negative feedback loop to regulate V_{L}. As V_{L} goes up (e.g., due to changes in the output load), it causes N1 to go lower, which causes N2 to go up thereby turning down P1 and turning up N1 to bring V_{L} back down. It works the same way, but in the opposite direction, when V_{L} goes down. Resistor RL and capacitor CL are coupled in series between V_{L} and VSS to provide stability at the output, V_{L}.

The high side driver is configured and operates essentially the same as the low side driver, so it will not be described to the same extent. However, it's worth pointing out that in some embodiments, with the high side driver, because the high rail, V_{H}, may serve primarily as a current source, the pull-up FET, P2, may be sized larger than the pull-down transistor N2 and in some cases, N2 may be omitted altogether. Conversely, with the low side driver, the pull-down transistor N1 may be sized larger than P1 when the low rail, V_{L}, serves primarily as a current sink. In some embodiments, P1 may be omitted altogether.

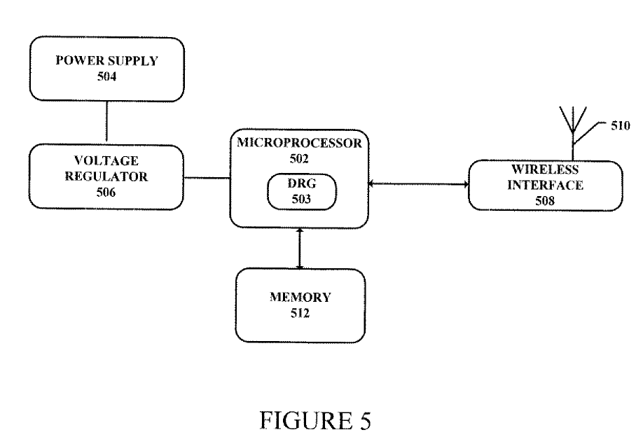

With reference to FIG. 5, one example of a computer system is shown. The depicted system generally comprises a processor 502 that is coupled to a voltage regulator 506, a wireless interface 508, and to memory 512. It is coupled to the voltage regulator 506 to receive from it at least one regulated voltage supply, derived from a power supply 504. The wireless interface 508 is coupled to an antenna 510 to communicatively link the processor through the wireless interface chip 508 to a wireless network (not shown). The voltage regulator 506 comprises one or more dual rail generator circuits 503 such as are disclosed herein to provide a controllable high and low supply rail, e.g., for a power management system or for a fixed reference PWM, e.g., in a voltage regulator circuit.

It should be noted that the depicted system could be implemented in different forms. That is, it could be implemented on a circuit board, or a chassis having multiple circuit boards. Similarly, it could constitute one or more complete computers or alternatively, it could constitute a component useful within a computing system.

The invention is not limited to the embodiments described, but can be practiced with modification and alteration within the spirit and scope of the appended claims. For example, it should be appreciated that the present invention is applicable for use with all types of semiconductor integrated circuit (“IC”) chips. Examples of these IC chips include but are not limited to processors, controllers, chip set components, programmable logic arrays (PLA), memory chips, network chips, and the like.

Moreover, it should be appreciated that example sizes/models/values/ranges may have been given, although the present invention is not limited to the same. As manufacturing techniques (e.g., photolithography) mature over time, it is expected that devices of smaller size could be manufactured. In addition, well known power/ground connections to IC chips and other components may or may not be shown within the FIGS. for simplicity of illustration and discussion, and so as not to obscure the invention. Further, arrangements may be shown in block diagram form in order to avoid obscuring the invention, and also in view of the fact that specifics with respect to implementation of such block diagram arrangements are highly dependent upon the platform within which the present invention is to be implemented, i.e., such specifics should be well within purview of one skilled in the art. Where specific details (e.g., circuits) are set forth in order to describe example embodiments of the invention, it should be apparent to one skilled in the art that the invention can be practiced without, or with variation of, these specific details. The description is thus to be regarded as illustrative instead of limiting.

What is claimed is,

1. A chip, comprising:
a dual rail generator to generate adjustable high and low voltage supplies based on applied amplitude and offset signals, wherein the difference between the high and low voltage supplies is proportional to the amplitude signal minus any reference component.

2. The chip of claim 1, in which the amplitude signal can be decomposed into an amplitude and a reference component.

3. The chip of claim 2, in which the dual rail generator comprises a dual rail reference generator to generate high and low reference signals and an output driver section comprising a high side driver coupled to the high reference signal to drive the high voltage supply and a low side driver coupled to the low reference signal to drive the low voltage supply.

4. The chip of claim 3, in which the dual rail reference generator comprises at least one analog amplifier formed from an inverter circuit having a resistor coupled between its output and input, the inverter having an associated trip point.

5. The chip of claim 4, in which the trip point corresponds to the level of the reference component in the amplitude signal.

6. The chip of claim 5, in which the inverter circuit comprises a PMOS transistor coupled to an NMOS transistor.

7. The chip of claim 3, in which the dual rail reference generator comprises at least one analog summing amplifier formed from an inverter.

8. The chip of claim 2, in which the high side driver comprises mirror-coupled inverters coupled between the high side reference signal and the high voltage supply as part of a loop to regulate the high voltage supply.

9. The chip of claim 2, in which the high side driver comprises a pull-up transistor at its output to source current through the high voltage supply, and the low side driver comprising a pull-down transistor to sink current through the low voltage supply.

10. An apparatus, comprising:
a dual rail reference generator comprising a high side section to generate a high reference signal and a low side section to generate a low reference signal; and
an output driver section coupled to the high and low reference signals to provide regulated high and low supply rails based on amplitude and offset signals applied to the dual rail reference generator.

11. The apparatus of claim 10, in which the dual rail reference generator comprises inverter circuits configured to function as analog summing amplifiers.

12. The apparatus of claim 11, in which the inverter circuits have the same associated trip point used as a reference voltage level, the amplitude signal comprising a reference component corresponding to this reference voltage level and an amplitude component corresponding to half of the difference between the high and low supply rails.

13. The apparatus of claim 12, in which the offset signal comprises a reference component corresponding to the reference voltage level and an offset component corresponding to a shift in the high and low supply rails.

14. The apparatus of claim 10, in which the output driver section comprises a first driver to drive the high supply rail and a second driver to drive the low supply rail.

15. The apparatus of claim 14, in which the first driver drives the high supply rail based on the high side reference signal, and the second driver drives the low supply rail based on the low side reference signal.

16. The apparatus of claim 15, in which the first and second drivers each comprise a pair of mirror coupled inverters to provide an inverted analog version of the reference signals relative to the reference voltage.

17. The apparatus of claim 10, in which the dual rail reference generator comprises an inverter with a resistor coupled between its input and output to provide an inverting analog amplifier.

18. A system, comprising;
(a) a microprocessor comprising a dual rail generator to generate adjustable high and low voltage supplies based on applied amplitude and offset signals, wherein the difference between the high and low voltage supplies is proportional to the amplitude signal minus any reference component; and
b) a wireless interface coupled to the microprocessor and to the antenna to communicatively link the microprocessor to a wireless network.

19. The system of claim 18, in which the difference between the high and low supplies is twice the amplitude signal after any reference component is removed.

20. The system of claim 18, in which the dual rail generator comprises at least one inverter configured and to be used as an inverting analog amplifier.

21. The system of claim 20, in which the dual rail generator comprises a driver having a pair of mirror-coupled inverters to drive the high voltage supply.
